(19) United States
(12) Patent Application Publication
(10) Pub. No.: US 2025/0050778 A1
(43) Pub. Date: Feb. 13, 2025

(54) ELECTRICITY SUPPLY INFORMATION PROVISION SYSTEM, ELECTRICITY SUPPLY INFORMATION PROVISION METHOD, AND STORAGE MEDIUM

(71) Applicant: TOYOTA JODOSHA KABUSHIKI KAISHA, Toyota-shi (JP)

(72) Inventors: Ryosuke KOBAYASHI, Nagakute-shi (JP); Koichi Watanabe, Tokyo (JP); Motofumi Kamiya, Nagoya-shi (JP); Masaki Nishino, Anjo-shi (JP); Jean-Sebastien Boire, Yokohama-shi (JP); Takuya Nishioka, Nagoya-shi (JP); Yohei Nakanishi, Nagoya-shi (JP); Masaki Makihara, Okazaki-shi (JP)

(73) Assignee: TOYOTA JODOSHA KABUSHIKI KAISHA, Toyota-shi (JP)

(21) Appl. No.: 18/793,052

(22) Filed: Aug. 2, 2024

(30) Foreign Application Priority Data
Aug. 10, 2023 (JP) 2023-131626

(51) Int. Cl. B60L 53/66; B60L 53/57; B60L 53/62

(52) U.S. Cl. CPC B60L 53/66; B60L 53/57; B60L 53/62; B60L 2240/54; B60L 2240/64; B60L 2240/68; B60L 2250/16

(57) ABSTRACT

An electricity supply information provision system includes: an information processing device including a first processor; and a terminal device including a second processor. The second processor transmits, to the information processing device, information related to a request to use a charging service from an electricity supply vehicle that performs charging of a user vehicle. The first processor identifies, based on road information, one or more places that satisfy a condition of use of the charging service. The first processor transmits information on the one or more places to the terminal device. The second processor displays the one or more places on a screen of the terminal device by using the information on the one or more places.

### CROSS-REFERENCE TO RELATED APPLICATION

This application claims priority to Japanese Patent Application No. 2023-131626 filed on Aug. 10, 2023 incorporated herein by reference in its entirety.

### BACKGROUND

### 1. Technical Field

The present disclosure relates to an electricity supply information provision system, an electricity supply information provision method, and a storage medium.

### 2. Description of Related Art

There has been known technology in which electricity is supplied by an electricity supply vehicle, for example, when an electrified vehicle runs out of electricity. For example, Japanese Unexamined Patent Application Publication No. 2019-086841 discloses a technology in which a vehicle running out of electricity transmits information including the current position of the own vehicle to a server, and a plurality of electricity supply vehicles each transmit information including the current position of the own vehicle to the server, whereby the server selects an electricity supply vehicle to supply electricity to the vehicle running out of electricity.

There has been room for improvement in the technology in which electricity is supplied by an electricity supply vehicle.

### SUMMARY

The present disclosure improves the technology in which electricity is supplied by an electricity supply vehicle.

According to one aspect of the present disclosure, an electricity supply information provision system includes: an information processing device including a first processor; and a terminal device including a second processor. The second processor is configured to transmit, to the information processing device, information related to a request to use a charging service from an electricity supply vehicle that performs charging of a user vehicle. The first processor is configured to identify, based on road information, one or more places that satisfy a condition of use of the charging service, and transmit information on the one or more places to the terminal device. The second processor is configured to display the one or more places on a screen of the terminal device by using the information on the one or more places.

Another aspect of the present disclosure is an electricity supply information provision method for a system including an information processing device and a terminal device. The method includes: from the terminal device to the information processing device, transmitting information related to a request to use a charging service from an electricity supply vehicle that performs charging of a user vehicle; by the information processing device, identifying, based on road information, one or more places that satisfy a condition of use of the charging service; from the information processing device to the terminal device, transmitting information on the one or more places; and on a screen of the terminal device, displaying the one or more places by using the information on the one or more places.

According to a still another aspect of the present disclosure, a non-transitory storage medium stores instructions. The instructions are executable by one or more processors in an electricity supply information provision system including an information processing device and a terminal device, and cause the one or more processors to perform functions. The functions include: from the terminal device to the information processing device, transmitting information related to a request to use a charging service from an electricity supply vehicle that performs charging of a user vehicle; by the information processing device, identifying, based on road information, one or more places that satisfy a condition of use of the charging service; from the information processing device to the terminal device, transmitting information on the one or more places; and on a screen of the terminal device, displaying the one or more places by using the information on the one or more places.

According to the present disclosure, the technology in which electricity is supplied by an electricity supply vehicle is improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of a terminal device;

FIG. 3 is a block diagram showing a schematic configuration of an information processing device; and

FIG. 4 is a sequence chart showing operation in the system.

### DETAILED DESCRIPTION OF EMBODIMENTS

Hereinafter, an embodiment of the present disclosure is described.

### Outline of Embodiment

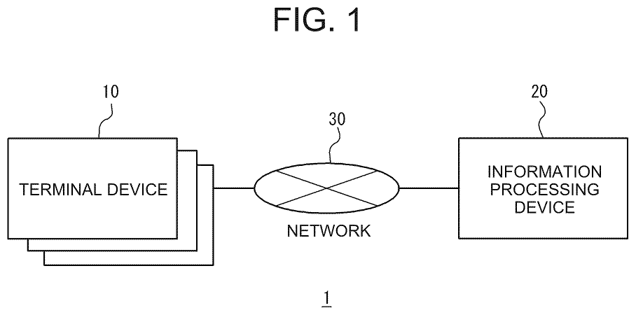

With reference to FIG. 1, an outline of a system 1 according to an embodiment of the present disclosure is described. The system 1 includes a plurality of terminal devices 10 and an information processing device 20. Each terminal device 10 and the information processing device 20 is communicably connected to a network 30 including, for example, the Internet, a mobile communication network, and the like.

Each terminal device 10 is, for example, a computer such as a personal computer (PC), a smartphone, or a tablet terminal. In the present embodiment, each terminal device 10 is used by a user who uses, for example, a service of delivering an electricity supply vehicle to a place designated by the user and supplying electricity to a vehicle of the user at the place (hereinafter, also referred to as “emergency charging service”). Each terminal device 10 may be a computer mounted in a vehicle.

The information processing device 20 is, for example, a computer such as a server device. The information processing device 20 is capable of communicating with the plurality of terminal devices 10 via the network 30.

The outline of the present embodiment is described first, and details thereof are described later. In the system 1 including the terminal devices 10 and the information processing device 20, when the information processing device 20 receives from a terminal device 10 information related to a request to use the charging service in which an electricity supply vehicle performs charging of a user vehicle, the information processing device 20 identifies one or more places that satisfy a condition of use of the charging service, based on road information. Subsequently, the information processing device 20 transmits information on the identified one or more places to the terminal device 10. The terminal device 10 then displays the one or more places on a screen of the terminal device 10, by using the information on the one or more places received from the information processing device 20.

To use the emergency charging service, a place is needed that includes a road where parking is possible. According to the present embodiment, it is possible to confirm, from the terminal device 10, a place where the emergency charging service can be used. Occurrence of the inconvenience that the service cannot be used at the place designated by the user can be reduced. As a result, the convenience of the emergency charging service can be enhanced. Accordingly, according to the present embodiment, the technology in which electricity is supplied by an electricity supply vehicle can be improved, in respect of enhancement of the convenience of the emergency charging service.

Next, each component of the system 1 is described in detail.

### Configuration of Terminal Device

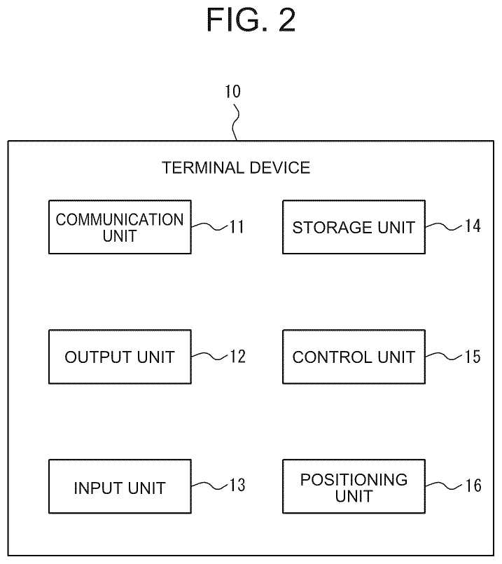

As shown in FIG. 2, each terminal device 10 includes a communication unit 11, an output unit 12, an input unit 13, a storage unit 14, a control unit 15, and a positioning unit 16.

The communication unit 11 includes one or more communication interfaces that connect to the network 30. For example, the communication interface supports, but is not limited to, a mobile telecommunications standard such as 4th generation (4G) or 5th generation (5G). In the present embodiment, the terminal device 10 communicates with the information processing device 20 via the communication unit 11 and the network 30.

The output unit 12 includes one or more output devices that output information. For example, the output device is, but is not limited to, a display that outputs information in the form of video, a speaker that outputs information in the forms of sound, or the like. Alternatively, the output unit 12 may include an interface for connection of an external output device.

The input unit 13 includes one or more input devices that detect an input operation made by a user. For example, the input device is, but is not limited to, a physical key, a capacitive key, a mouse, a touch panel, a touch screen installed integrally with the display of the output unit 12, a microphone, or the like. Alternatively, the input unit 13 may include an interface for connection of an external input device.

The storage unit 14 includes one or more memories. For example, the memory is, but is not limited to, a semiconductor memory, a magnetic memory, an optical memory, or the like. Each memory included in the storage unit 14 may function as, for example, a main storage device, an auxiliary storage device, or a cache memory. The storage unit 14 stores arbitrary information that is used in operation of the terminal device 10. The arbitrary information that is used in operation of the terminal device 10 includes state of charge (SOC). Moreover, for example, the storage unit 14 may store a system program, an application program, embedded software, and the like. For example, the information stored in the storage unit 14 may be updatable with, for example, information acquired from the network 30 via the communication unit 11.

The control unit 15 includes one or more processors, one or more programmable circuits, one or more dedicated circuits, or a combination thereof. For example, the processor is, but is not limited to, a general-purpose processor such as a central processing unit (CPU) or a graphics processing unit (GPU), or a dedicated processor specialized for a specific process. For example, the programmable circuit is, but is not limited to, a field-programmable gate array (FPGA). For example, the dedicated circuit is, but is not limited to, an application specific integrated circuit (ASIC). The control unit 15 controls entire operation of the terminal device 10.

The positioning unit 16 includes one or more devices that acquire position information on the terminal device 10. Specifically, for example, the positioning unit 16 includes, but is not limited to, a receiver supporting GPS, and may include a receiver supporting an arbitrary satellite positioning system.

### Configuration of Information Processing Device

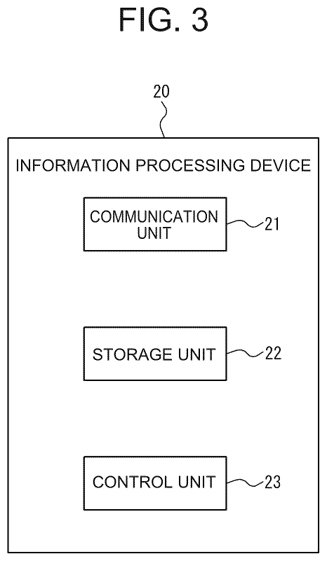

As shown in FIG. 3, the information processing device 20 includes a communication unit 21, a storage unit 22, and a control unit 23.

The communication unit 21 includes one or more communication interfaces that connect to the network 30. For example, the communication interface supports, but is not limited to, a mobile telecommunications standard, a wired local area network (LAN) standard, or a wireless LAN standard, and may support an arbitrary communication standard. In the present embodiment, the information processing device 20 communicates with the plurality of terminal devices 10 via the communication unit 21 and the network 30.

The storage unit 22 includes one or more memories. Each memory included in the storage unit 22 may function as, for example, a main storage device, an auxiliary storage device, or a cache memory. The storage unit 22 stores arbitrary information that is used in operation of the information processing device 20. For example, the storage unit 22 may store a system program, an application program, embedded software, a database, and the like. The information stored in the storage unit 22 may be updatable with, for example, information acquired from the network 30 via the communication unit 21.

The control unit 23 includes one or more processors, one or more programmable circuits, one or more dedicated circuits, or a combination thereof. For example, the processor is, but is not limited to, a general-purpose processor such as a central processing unit (CPU) or a graphics processing unit (GPU), or a dedicated processor specialized for a specific process. For example, the programmable circuit is, but is not limited to, a field-programmable gate array (FPGA). For example, the dedicated circuit is, but is not limited to, an application specific integrated circuit (ASIC). The control unit 23 controls entire operation of the information processing device 20.

### Operation Flow of System 1

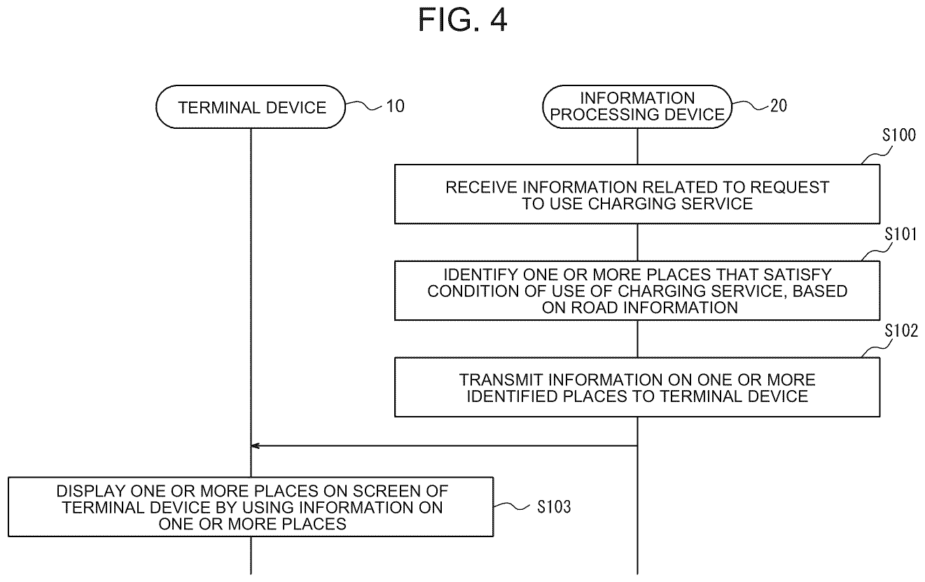

With reference to FIG. 4, a description is given of operation of each terminal device 10 and the information processing device 20 in the system 1 according to the present embodiment.

S100: The control unit 23 of the information processing device 20 receives, from a terminal device 10, information related to a request to use the charging service in which an electricity supply vehicle performs charging of a user vehicle.

Specifically, a user who wants to use the emergency charging service inputs information related to the request to use the charging service, by using the terminal device 10. The input of the information related to the request to use the charging service may be performed, for example, by using an input form displayed on a screen of the terminal device 10, or by opening a site for making a booking for use of the emergency charging service in a browser. An arbitrary input method that is not limited to such methods can be adopted. The control unit 15 of the terminal device 10 transmits the information to the information processing device 20 via the communication unit 11 and the network 30. The control unit 23 receives the information via the communication unit 21.

The “information related to the request to use the charging service” includes, for example, a signal, to the server, that requests use of the charging service.

S101: The control unit 23 identifies one or more places that satisfy a condition of use of the charging service, based on road information.

The “road information” is arbitrary information from which the situation of a road can be grasped. For example, the road information may include image information obtained by capturing an image of the road. For example, the road information may include, but is not limited thereto, any one or more of the traffic volume on, the width of, and a record of accidents on the road, and may include arbitrary information from which the situation of the road can be grasped.

For example, the road information may be acquired from a surveillance camera installed around a road, may be acquired from the storage unit 22 of the information processing device 20, or may be acquired from another information processing device (for example, a server in a road traffic information center) that can communicate with the information processing device 20, or alternatively, may be a combination thereof.

The “condition of use” may be arbitrarily set. For example, the condition of use may include a condition that the place in question has enough space to allow two or more vehicles to be parked next to each other. In such a case, the control unit 23 identifies the one or more places by determining whether or not the place in question has enough space to allow two or more vehicles to be parked next to each other, for example, by using the road information, such as the image information obtained by capturing an image of the road, the width of the road, or the number of lanes.

For example, when the image information is used for the road information, the control unit 23 may identify the one or more places by determining whether or not another vehicle is already parked on the road in the image. For example, when the width of the road is used for the road information, the control unit 23 may identify the one or more places by determining whether or not the road has enough width to allow two vehicles to be parked on the road and also allow one or more other vehicles to go past. Alternatively, for example, when the number of lanes is used for the road information, the control unit 23 may identify the one or more places by determining whether or not the number of lanes is three or more.

Moreover, for example, the condition of use may include a condition that the traffic volume in the place in question is less than a predetermined value. In such a case, the control unit 23 identifies the one or more places by determining whether or not the traffic volume in the place is less than the predetermined value, for example, by using the road information such as the image information obtained by capturing an image of the road or the traffic volume on the road. Note that the predetermined value related to the traffic volume may be variable.

Further, for example, the condition of use may include a condition that a record of accidents in the place in question is less than a predetermined value. In such a case, the control unit 23 identifies the one or more places by determining whether or not a record of accidents in the place is less than the predetermined value, by using the road information such as a record of accidents on the road. Note that the predetermined value related to the record of accidents may be variable.

For example, the control unit 23 may identify the one or more places, further based on the size of the electricity supply vehicle and/or the size of the user vehicle. Specifically, when the condition of use includes the condition that the place has enough space to allow two or more vehicles to be parked next to each other, the control unit 23 identifies the one or more places by determining whether or not a road has enough width to allow two vehicles be parked on the road and also allow one or more other vehicles to go past, by further using information on the size of the electricity supply vehicle and/or information on the size of the user vehicle. Note that, for example, the control unit 23 may acquire the information on the size of the electricity supply vehicle and/or the information on the size of the user vehicle from the storage unit 22 of the information processing device 20, or may receive from the terminal device 10 of the electricity supply vehicle and/or the terminal device 10 of the user vehicle.

For example, the control unit 23 may identify the one or more places, further based on a record of use of the charging service at the one or more places. Specifically, for example, the control unit 23 identifies one or more places that satisfy the condition of use of the charging service as described above and then, based on whether or not a record of use of the charging service at each of the one or more places is less than a predetermined value, further identifies one or more places. Note that, for example, the control unit 23 may acquire the record of use of the charging service at each of the one or more places from the storage unit 22 of the information processing device 20. The predetermined value related to the record of use of the charging service may be variable.

S102: The control unit 23 transmits information on the identified one or more places to the terminal device 10.

Specifically, the control unit 23 transmits the information on the identified one or more places to the terminal device 10 via the communication unit 21 and the network 30.

S103: The control unit 15 of the terminal device 10 displays the one or more places on a screen of the terminal device 10 by using the information on the one or more places received from the information processing device 20.

Specifically, the control unit 15 receives the information on the one or more places from the information processing device 20 via the communication unit 11 and the network 30. By using the received information on the one or more places, the control unit 15 displays the one or more places on the screen of the terminal device 10, in an arbitrary way, for example, displaying the one or more places on a map displayed on the screen, or displaying information, such as addresses, on the one or more places in the form of a list.

For example, the control unit 15 may output the received information on the one or more places by using the speaker of the terminal device 10.

As described above, in the system 1 including the terminal devices 10 and the information processing device 20, when the information processing device 20 receives from a terminal device 10 information related to a request to use the charging service in which an electricity supply vehicle performs charging of a user vehicle, the information processing device 20 identifies one or more places that satisfy the condition of use of the charging service, based on road information. Subsequently, the information processing device 20 transmits information on the identified one or more places to the terminal device 10. The terminal device 10 displays the one or more places on the screen of the terminal device 10 by using the information on the one or more places received from the information processing device 20.

According to such a configuration, it is possible to confirm, from each terminal device 10, a place where the emergency charging service can be used. Occurrence of the inconvenience that the service cannot be used at a place designated by a user can be reduced. As a result, the convenience of the emergency charging service can be enhanced. Accordingly, according to the present embodiment, the technology in which electricity is supplied by an electricity supply vehicle is improved, in respect of enhancement of the convenience of the emergency charging service.

Although the present disclosure has been described based on the various drawings and examples, a person skilled in the art may make various modifications and alterations based on the present disclosure. Accordingly, such modifications and alterations are included in the scope of the present disclosure. For example, functionality or the like included in each constituent unit, each step, or the like can be reconfigured in such a manner that no logical inconsistency occurs. A plurality of constituent units, steps, or the like can be combined into one, or can be further divided.

For example, an embodiment is possible in which the configuration and the operation of each terminal device 10 and/or the information processing device 20 in the described embodiment are distributed between or among a plurality of computers that is capable of mutual communication. For example, an embodiment is also possible in which some or all, of the constituent elements of the information processing device 20 are provided to each terminal device 10. An embodiment is also possible in which, conversely, some or all, of the constituent elements of each terminal device 10 are provided to the information processing device 20. For example, each terminal device 10 may include some or all, of the constituent elements of the information processing device 20. The information processing device 20 may include some or all, of the constituent elements of each terminal device 10.

For example, in the described embodiment, the terminal device 10 may notify the information processing device 20 of a place selected by the user among the one or more places displayed on the screen, as a booked place to perform the charging service. Thereafter, the information processing device 20 may accept a booking of the charging service, based on information on the booked place.

Specifically, in S103, the control unit 15 of the terminal device 10 displays the one or more places received from the information processing device 20 in a user-selectable manner. For example, the user can select a place by touching the place with a finger. Subsequently, the control unit 15 decides on the place selected by the user as the booked place to perform the charging service. For example, the decision includes pressing an arbitrary button, but an arbitrary scheme that is not limited thereto may be adopted. After the decision, the control unit 15 notifies the booked place to perform the charging service to the information processing device 20 via the communication unit 11 and the network 30. The information processing device 20 accepts the booking of the charging service, through a method based on information on the booked place. For example, the information processing device 20 decides on an electricity supply vehicle to assign, based on the information on the booked place received from the terminal device 10.

For example, in the described embodiment, the information processing device 20 may repeatedly acquire road information at predetermined time intervals. In such a case, the information processing device 20 newly identifies one or more places that satisfy the condition of use of the charging service, based on the acquired latest road information. When the newly identified one or more places are different from the previously identified one or more places, the information processing device 20 notifies the newly identified one or more places to the terminal device 10.

The “predetermined time interval” may be any one of arbitrary time intervals including every one second, every two seconds, every five seconds, every 10 seconds, every one minute, every two minutes, every 10 minutes, every 30 minutes, and every one hour. The predetermined time interval may be appropriately variable.

Alternatively, the information processing device 20 may acquire road information in real time.

For example, in the described embodiment, the terminal device 10, when transmitting the information related to the request to use the charging service, may transmit position information on the terminal device 10 to the information processing device 20. The information processing device 20 may identify the one or more places, further based on the position information received from the terminal device 10.

The “position information” may include arbitrary information indicating a place, such as an address, a latitude and a longitude, or a facility name.

Specifically, in S100, when transmitting the information related to the request to use the charging service via the communication unit 11, the control unit 15 of the terminal device 10 transmits the position information on the terminal device 10 to the information processing device 20. For acquisition of the position information on the terminal device 10, an arbitrary scheme, such as using GPS, can be adopted. The control unit 23 of the information processing device 20 identifies one or more places that satisfy the condition of use and that are within a predetermined distance of the position of the terminal device 10 received from the terminal device 10.

Alternatively, the terminal device 10 may identify one or more places, further based on the position information on the terminal device 10. In such a case, in S103, the control unit 15 of the terminal device 10 may display, on the screen of the terminal device 10, the one or more places that are further identified by using the information on the one or more places received from the information processing device 20 and the position information on the terminal device 10, without transmitting the position information on the terminal device 10 to the information processing device 20.

The “predetermined distance” may be any one of arbitrary distances including 100 m, 200 m, 500 m, 1 km, 2 km, 5 km, 10 km, and the like. The predetermined distance may be variable. The predetermined distance may be calculated by using the state of charge (SOC) of the user vehicle, which will be described later.

For example, in the described embodiment, when transmitting the information related to the request to use the charging service, the terminal device 10 may notify the SOC of the user vehicle to the information processing device 20. The information processing device 20 may identify the one or more places, further based on the SOC received from the terminal device 10.

Specifically, in S100, when transmitting the information related to the request to use the charging service and the position information on the terminal device 10 via the communication unit 11, the control unit 15 of the terminal device 10 notifies the SOC of the user vehicle related to the terminal device 10 to the information processing device 20. The control unit 23 of the information processing device 20 decides on a distance to empty calculated from the SOC, as the predetermined distance. Thereafter, the control unit 23 identifies the one or more places that satisfy the condition of use and that are within the predetermined distance of the position of the terminal device 10 received from the terminal device 10.

Alternatively, the terminal device 10 may identify one or more places, further based on the SOC of the user vehicle. In such a case, in S103, the control unit 15 of terminal device 10 may display, on the screen of the terminal device 10, the one or more places that satisfy the condition of use and that are within the predetermined distance of the position of the terminal device 10, using the information on the one or more places received from the information processing device 20, the position information on the terminal device 10, and the SOC of the user vehicle, without transmitting the position information on the terminal device 10 to the information processing device 20.

In the described embodiment, the terminal device 10 may change a display form of each of the one or more places, according to a degree of advisability of each of the one or more places.

Specifically, the control unit 23 of the information processing device 20 sets a degree of advisability for each of the one or more places identified in S101. For example, the more difficult it is for the one or more places to be congested, due to a small traffic volume, a wide road width, and/or many lanes in the one or more places, the higher degree of advisability the control unit 23 may set. The lower risk the one or more places have, due to a record of many uses and/or a record of a few accidents in the one or more places, the higher degree of advisability the control unit 23 may set. Conditions are not limited thereto, and the control unit 23 may set a degree of advisability for each of the one or more places, based on various conditions. The degree of advisability set for each of the one or more places may be included in the information on the one or more places. In S103, the control unit 15 of the terminal device 10 displays the one or more places on the screen of the terminal device 10, with the display form of each of the one or more places being changed according to each corresponding degree of advisability included in the information on the one or more places.

Examples of the “display form” include display using colors such as red, blue, and yellow, display using shapes such as a circle and a double circle, and display using numbers or symbols. Various forms that are not limited thereto may be used.

In the described embodiment, when the number of the one or more places is less than a predetermined number, the terminal device 10 may display information that proposes using a toll parking lot as a booked place to perform the charging service.

To display the information that proposes using a toll parking lot as a booked place to perform the charging service, toll parking lot information stored in the storage unit 14 may be used. Alternatively, the control unit 15 of the terminal device 10 may ask the information processing device 20 for information that proposes using a toll parking lot. Alternatively, the control unit 15 may acquire toll parking lot information, for example, from a server of a parking lot operator.

Alternatively, the control unit 23 of the information processing device 20 may determine whether or not the number of the one or more places is less than the predetermined number. In such a case, the control unit 23 may use the toll parking lot information stored in the storage unit 22. Alternatively, the control unit 23 may acquire toll parking lot information, for example, from a server of a parking lot operator.

The information that proposes using a toll parking lot as a booked place to perform the charging service may be displayed in the same method that is used to display the one or more places, or by using a different method.

The “predetermined number” is an arbitrary integer. The predetermined number may be variable.

For example, an embodiment is also possible in which a general-purpose computer is caused to function as the information processing device 20 according to the described embodiment. Specifically, a program that describes the content of processes implementing each function of the information processing device 20 according to the described embodiment is stored in a memory of the general-purpose computer, and the program is read and executed by a processor. Accordingly, the present disclosure can also be implemented as a processor-executable program, or a non-transitory computer-readable medium storing the program.

Some embodiments of the present disclosure are illustrated below. However, embodiments of the present disclosure are not limited thereto.

### Supplement 1

A system including an information processing device and a terminal device, wherein:
when information related to a request to use a charging service from an electricity supply vehicle that performs charging of a user vehicle of a user is received from the terminal device, the information processing device identifies, based on road information, one or more places that satisfy a condition of use of the charging service, and transmits information on the identified one or more places to the terminal device; and
the terminal device displays the one or more places on a screen of the terminal device by using the information on the one or more places received from the information processing device.

### Supplement 2

The system according to supplement 1, wherein the road information includes image information obtained by capturing an image of a road.

### Supplement 3

The system according to supplement 1, wherein the road information includes at least one of a traffic volume on a road, a width of the road, and a record of accidents on the road.

### Supplement 4

The system according to supplement 1, wherein:
the terminal device notifies a place, as a booked place to perform the charging service, to the information processing device, the place being selected by the user among the one or more places displayed on the screen; and
the information processing device accepts a booking of the charging service, based on information on the booked place.

### Supplement 5

The system according to supplement 1, wherein the information processing device repeatedly acquires the road information at predetermined time intervals, newly identifies one or more places that satisfy the condition of use of the charging service, based on the acquired latest road information, and, when the newly identified one or more places are different from the previously identified one or more places, notifies the newly identified one or more places to the terminal device.

### Supplement 6

The system according to supplement 1, wherein:
the terminal device, when transmitting the information related to the request to use the charging service, transmits position information on the terminal device to the information processing device; and
the information processing device identifies the one or more places, further based on the position information received from the terminal device.

### Supplement 7

The system according to supplement 6, wherein:
the terminal device, when transmitting the information related to the request to use the charging service, notifies SOC of the user vehicle to the information processing device; and
the information processing device identifies the one or more places, further based on the SOC received from the terminal device.

### Supplement 8

The system according to supplement 1, wherein the condition of use of the charging service includes a condition that a place in question has enough space to allow two or more vehicles to be parked next to each other.

### Supplement 9

The system according to supplement 1, wherein the information processing device identifies the one or more places, further based on a size of the electricity supply vehicle and/or a size of the user vehicle.

### Supplement 10

The system according to supplement 1, wherein the information processing device identifies the one or more places, further based on a record of use of the charging service at the one or more places.

### Supplement 11

The system according to supplement 1, wherein the terminal device changes a display form of each of the one or more places, according to a degree of advisability of each of the one or more places.

### Supplement 12

The system according to supplement 1, wherein the terminal device, when the number of the one or more places is less than a predetermined number, displays information that proposes using a toll parking lot as a booked place to perform the charging service.

### Supplement 13

A method that is performed by a system including an information processing device and a terminal device, the method including:
from the terminal device to the information processing device, transmitting information related to a request to use a charging service from an electricity supply vehicle that performs charging of a user vehicle of a user;
by the information processing device, identifying, based on road information, one or more places that satisfy a condition of use of the charging service;
from the information processing device to the terminal device, transmitting information on the identified one or more places; and
on a screen of the terminal device, displaying the one or more places by using the information on the one or more places.

### Supplement 14

The method according to supplement 13, wherein the road information includes image information obtained by capturing an image of a road.

### Supplement 15

The method according to supplement 13, wherein the road information includes at least one of a traffic volume on a road, a width of the road, and a record of accidents on the road.

### Supplement 16

The method according to supplement 13, further including:
from the terminal device to the information processing device, notifying a place as a booked place to perform the charging service, the place being selected by the user among the one or more places displayed on the screen; and
by the information processing device, accepting a booking of the charging service, based on information on the booked place.

### Supplement 17

A program causing a processor of a system including an information processing device and a terminal device, to execute:
from the terminal device to the information processing device, transmitting information related to a request to use a charging service from an electricity supply vehicle that performs charging of a user vehicle of a user;
by the information processing device, identifying, based on road information, one or more places that satisfy a condition of use of the charging service;
from the information processing device to the terminal device, transmitting information on the one or more places; and
on a screen of the terminal device, displaying the one or more places by using the information on the one or more places.

### Supplement 18

The program according to supplement 17, causing the processor to further execute, from the terminal device to the information processing device, notifying a place as a booked place to perform the charging service, the place being selected by the user among the one or more places displayed on the screen.

### Supplement 19

The program according to supplement 17, causing the processor to further execute, from the terminal device to the information processing device, transmitting position information on the terminal device when transmitting the information related to the request to use the charging service.

### Supplement 20

The program according to supplement 19, causing the processor to further execute, on the terminal device, changing a display form of each of the one or more places, according to a degree of advisability of each of the one or more places.

What is claimed is:

1. An electricity supply information provision system comprising:
an information processing device including a first processor; and
a terminal device including a second processor, wherein
the second processor is configured to transmit, to the information processing device, information related to a request to use a charging service from an electricity supply vehicle that performs charging of a user vehicle of a user,
the first processor is configured to identify, based on road information, one or more places that satisfy a condition of use of the charging service, and transmit information on the one or more places to the terminal device, and
the second processor is configured to display the one or more places on a screen of the terminal device by using the information on the one or more places.

2. The electricity supply information provision system according to claim 1, wherein the road information includes image information obtained by capturing an image of a road.

3. The electricity supply information provision system according to claim 1, wherein the road information includes at least one of a traffic volume on a road, a width of the road, and a record of accidents on the road.

4. The electricity supply information provision system according to claim 1, wherein:
the second processor is configured to notify a place, as a booked place to perform the charging service, to the information processing device, the place being selected by the user among the one or more places; and
the first processor is configured to accept a booking of the charging service, based on information on the booked place.

5. The electricity supply information provision system according to claim 1, wherein the first processor is configured to
repeatedly acquire the road information at predetermined time intervals,
newly identify one or more places that satisfy the condition of use of the charging service, based on a latest road information, and
when one or more first places which are previously identified are different from one or more second places which are newly identified, notify the one or more second places to the terminal device.

6. The electricity supply information provision system according to claim 1, wherein:
the second processor is configured to, when transmitting the information related to the request to use the charging service, transmit position information on the terminal device to the information processing device; and
the first processor is configured to identify the one or more places, further based on the position information received from the terminal device.

7. The electricity supply information provision system according to claim 6, wherein:
the second processor is configured to, when transmitting the information related to the request to use the charging service, notify state of charge of the user vehicle to the information processing device; and
the first processor is configured to identify the one or more places, further based on the state of charge received from the terminal device.

8. The electricity supply information provision system according to claim 1, wherein the condition of use of the charging service includes a condition that a place in question has enough space to allow two or more vehicles to be parked next to each other.

9. The electricity supply information provision system according to claim 1, wherein the first processor is configured to identify the one or more places, further based on a size of the electricity supply vehicle and/or a size of the user vehicle.

10. The electricity supply information provision system according to claim 1, wherein the first processor is configured to identify the one or more places, further based on a record of use of the charging service at the one or more places.

11. The electricity supply information provision system according to claim 1, wherein the second processor is configured to change a display form of each of the one or more places, according to a degree of advisability of each of the one or more places.

12. The electricity supply information provision system according to claim 1, wherein the second processor is configured to, when a number of the one or more places is less than a predetermined number, display information that proposes using a toll parking lot as a booked place to perform the charging service.

13. An electricity supply information provision method for a system including an information processing device and a terminal device, the method comprising:
from the terminal device to the information processing device, transmitting information related to a request to use a charging service from an electricity supply vehicle that performs charging of a user vehicle of a user;
by the information processing device, identifying, based on road information, one or more places that satisfy a condition of use of the charging service;
from the information processing device to the terminal device, transmitting information on the one or more places; and
on a screen of the terminal device, displaying the one or more places by using the information on the one or more places.

14. The electricity supply information provision method according to claim 13, wherein the road information includes image information obtained by capturing an image of a road.

15. The electricity supply information provision method according to claim 13, wherein the road information includes at least one of a traffic volume on a road, a width of the road, and a record of accidents on the road.

16. The electricity supply information provision method according to claim 13, further comprising:
from the terminal device to the information processing device, notifying a place as a booked place to perform the charging service, the place being selected by the user among the one or more places; and
by the information processing device, accepting a booking of the charging service, based on information on the booked place.

17. A non-transitory storage medium storing instructions that are executable by one or more processors in an electricity supply information provision system including an information processing device and a terminal device, and that cause the one or more processors to perform functions comprising:
from the terminal device to the information processing device, transmitting information related to a request to use a charging service from an electricity supply vehicle that performs charging of a user vehicle of a user;
by the information processing device, identifying, based on road information, one or more places that satisfy a condition of use of the charging service;
from the information processing device to the terminal device, transmitting information on the one or more places; and
on a screen of the terminal device, displaying the one or more places by using the information on the one or more places.

18. The storage medium according to claim 17, wherein the functions further comprise, from the terminal device to the information processing device, notifying a place as a booked place to perform the charging service, the place being selected by the user among the one or more places.

19. The storage medium according to claim 17, wherein the functions further comprise, from the terminal device to the information processing device, transmitting position information on the terminal device when transmitting the information related to the request to use the charging service.

20. The storage medium according to claim 19, wherein the functions further comprise, on the terminal device, changing a display form of each of the one or more places, according to a degree of advisability of each of the one or more places.
